(19) United States
(12) Patent Application Publication
(10) Pub. No.: US 2025/0103957 A1
(43) Pub. Date: Mar. 27, 2025

(54) POLICY TRAINING DEVICE, POLICY TRAINING METHOD, AND COMMUNICATION SYSTEM

(71) Applicant: Fujitsu Limited, Kawasaki-shi (JP)

(72) Inventors: Yuta TERANISHI, Fukuoka (JP); Fumika ABE, Sasaguri (JP); Masatoshi OGAWA, Zama (JP); Natsuki ISHIKAWA, Yamato (JP); Yoshihiro OKAWA, Yokohama (JP)

(73) Assignee: Fujitsu Limited, Kawasaki-shi (JP)

(21) Appl. No.: 18/814,671

(22) Filed: Aug. 26, 2024

(30) Foreign Application Priority Data
Sep. 27, 2023 (JP) 2023-166312

(51) Int. Cl. G06N 20/00

(52) U.S. Cl. CPC G06N 20/00

(57) ABSTRACT

A policy training device that trains, through first reinforcement learning, a first agent configured to output a first action of a control object according to an input of a first state of the control object, includes a memory, and processor circuitry coupled to the memory and configured to change a first parameter regarding a constraint condition in the first reinforcement learning for every predetermined number of times of a training operation in the first reinforcement learning, and train the first agent by using the first parameter as at least a part of the first state and by ensuring that the constraint condition is satisfied.

### CROSS-REFERENCE TO RELATED APPLICATION

This application is based upon and claims the benefit of priority of the prior Japanese Patent Application No. 2023-166312, filed on Sep. 27, 2023, the entire contents of which are incorporated herein by reference.

### FIELD

The embodiments discussed herein are related to a policy training device, a policy training method, and a communication system.

### BACKGROUND

For example, there is a reinforcement learning technique for training an optimal policy for a control object (hereinafter, also referred to as an environment) with reference to a reward from the control object according to an action with respect to the control object. The policy is, for example, a function that determines a next action of the control object according to the state of the control object. For example, the reinforcement learning is a technique for training an agent on a policy capable of obtaining a higher reward while, for example, repeating trial and error based on experience.

International Publication Pamphlet No. WO 2022/044191 and Japanese Laid-open Patent Publication No. 2021-064222 are disclosed as related art.

### SUMMARY

According to an aspect of the embodiments, a policy training device that trains, through first reinforcement learning, a first agent configured to output a first action of a control object according to an input of a first state of the control object, the policy training device includes a memory, and a processor coupled to the memory and configured to change a first parameter regarding a constraint condition in the first reinforcement learning for every predetermined number of times of a training operation in the first reinforcement learning, and train the first agent by using the first parameter as at least a part of the first state and by ensuring that the constraint condition is satisfied.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRA WINGS

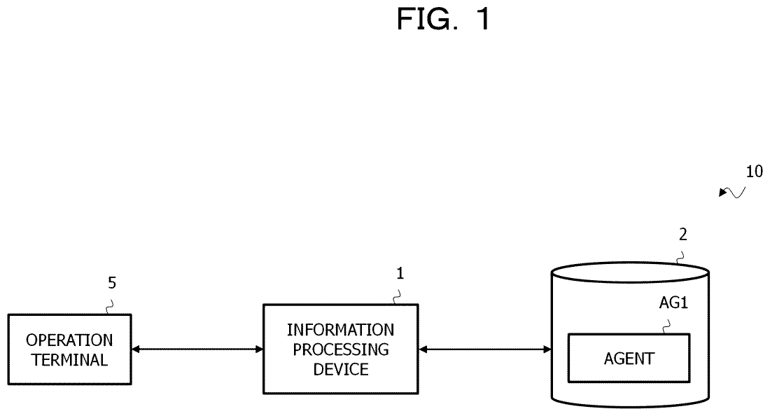

FIG. 1 is a diagram explaining a configuration of an information processing system 10;

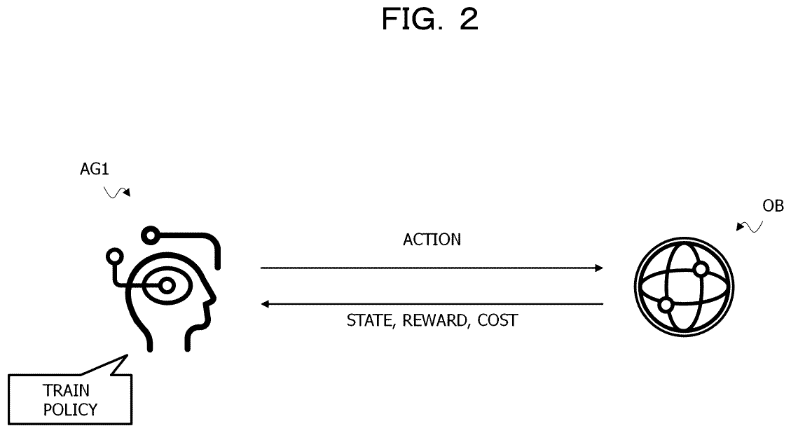

FIG. 2 is a diagram explaining constrained reinforcement learning;

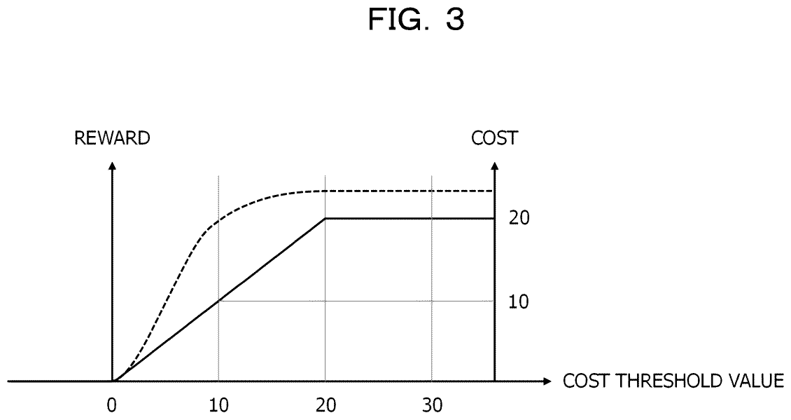

FIG. 3 is a graph illustrating a relationship between a reward, a cost, and a cost threshold value;

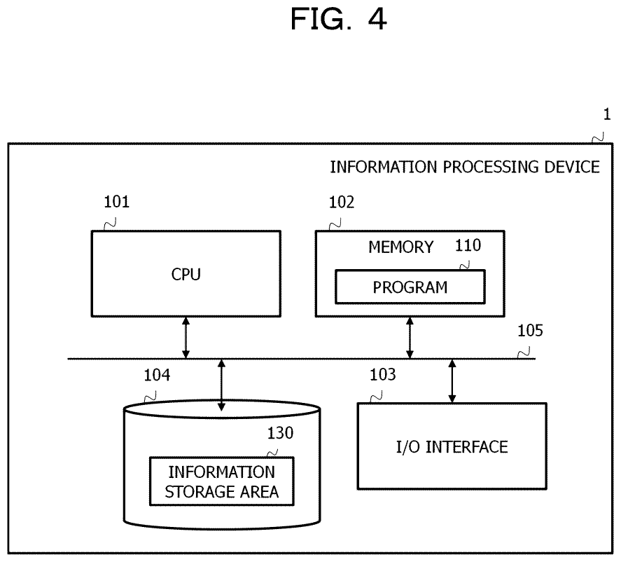

FIG. 4 is a diagram explaining a hardware configuration of an information processing device 1;

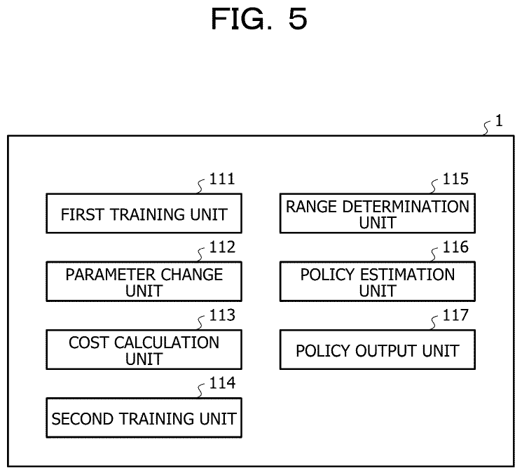

FIG. 5 is a diagram explaining functions in the information processing device 1;

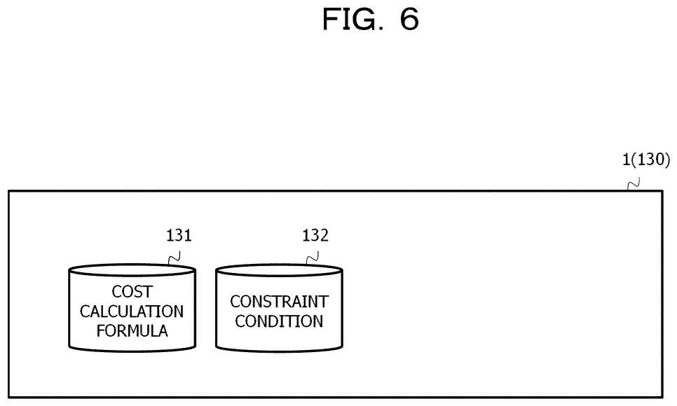

FIG. 6 is a diagram explaining information stored in an information storage area 130;

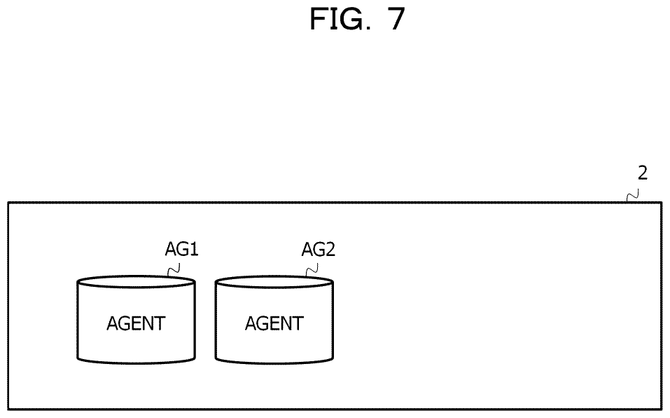

FIG. 7 is a diagram explaining agents AG stored in a storage device 2;

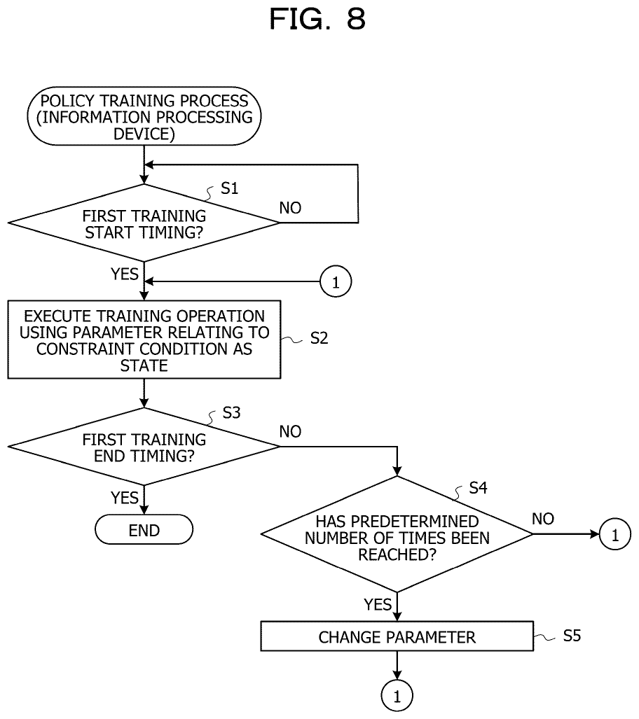

FIG. 8 is a flowchart diagram explaining an outline of a policy training process according to an embodiment;

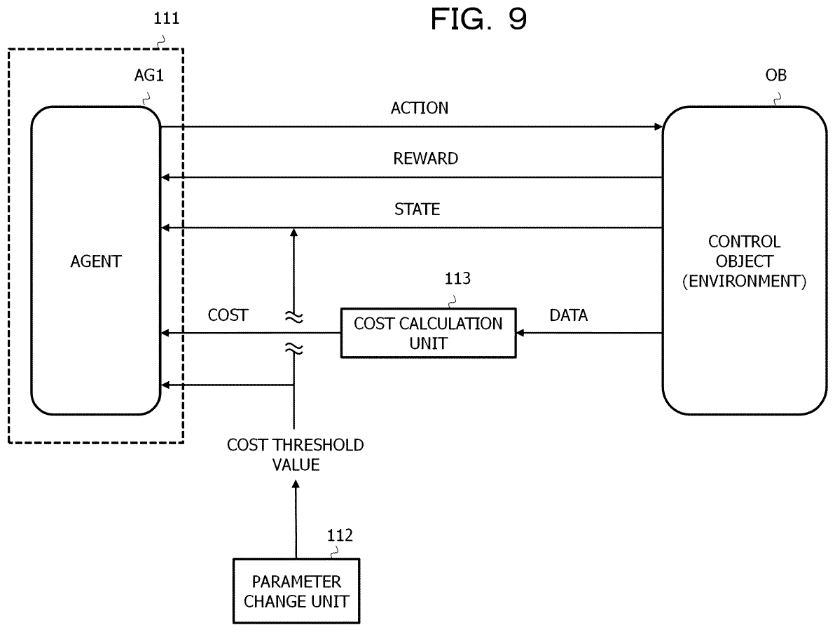

FIG. 9 is a diagram explaining a specific example of the policy training process in the embodiment;

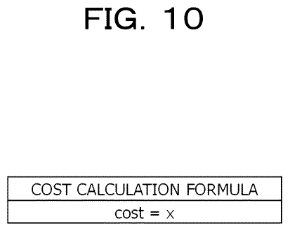

FIG. 10 is a diagram explaining a specific example of the policy training process in the embodiment;

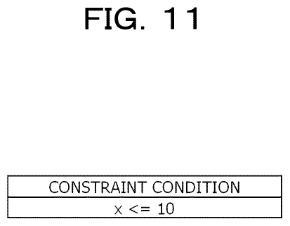

FIG. 11 is a diagram explaining a specific example of the policy training process in the embodiment;

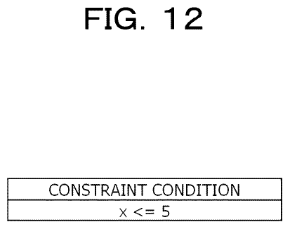

FIG. 12 is a diagram explaining a specific example of the policy training process in the embodiment;

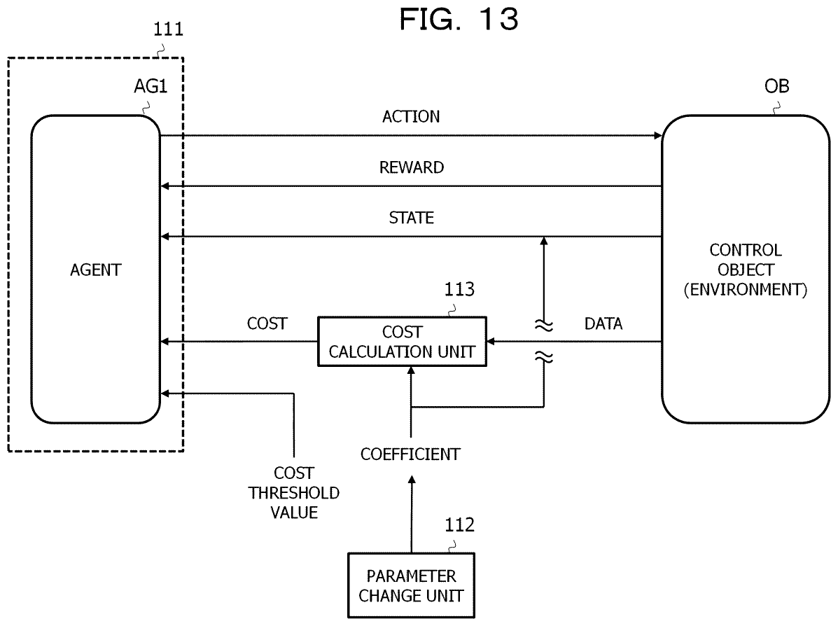

FIG. 13 is a diagram explaining a specific example of the policy training process in the embodiment;

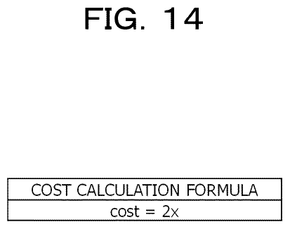

FIG. 14 is a diagram explaining a specific example of the policy training process in the embodiment;

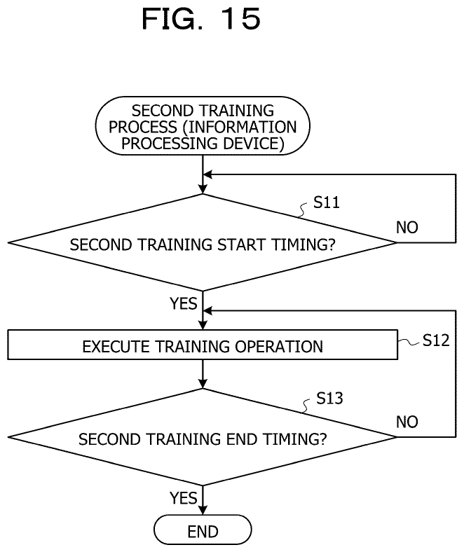

FIG. 15 is a flowchart diagram explaining details of the policy training process according to the embodiment;

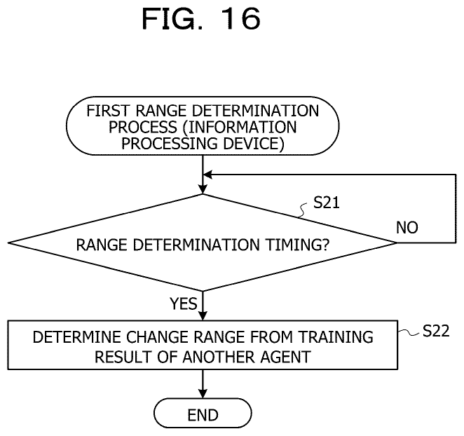

FIG. 16 is a flowchart diagram explaining details of the policy training process according to the embodiment;

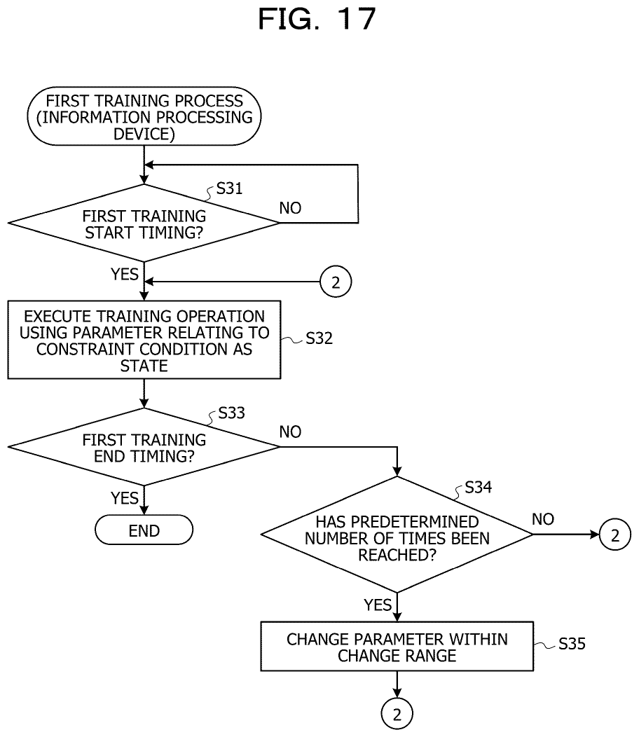

FIG. 17 is a flowchart diagram explaining details of the policy training process according to the embodiment;

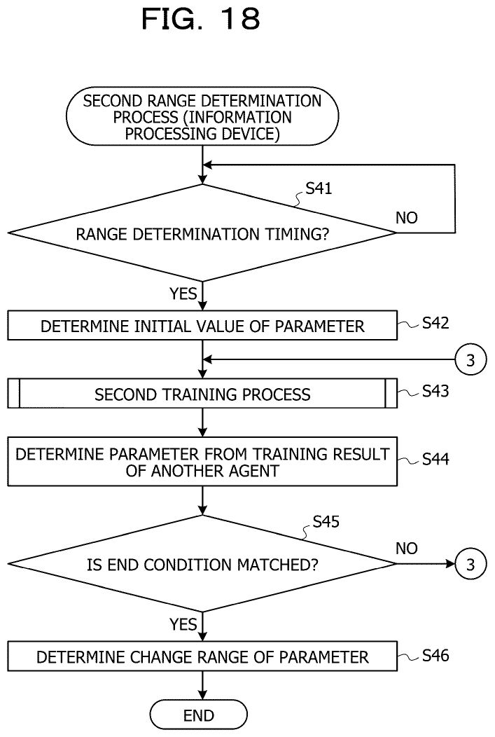

FIG. 18 is a flowchart diagram explaining details of the policy training process according to the first embodiment;

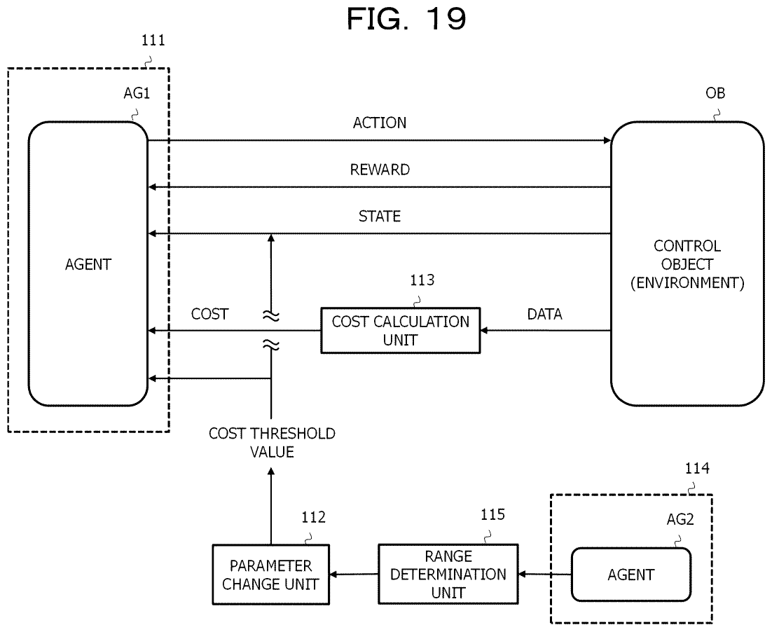

FIG. 19 is a diagram explaining another specific example of the policy training process in the embodiment;

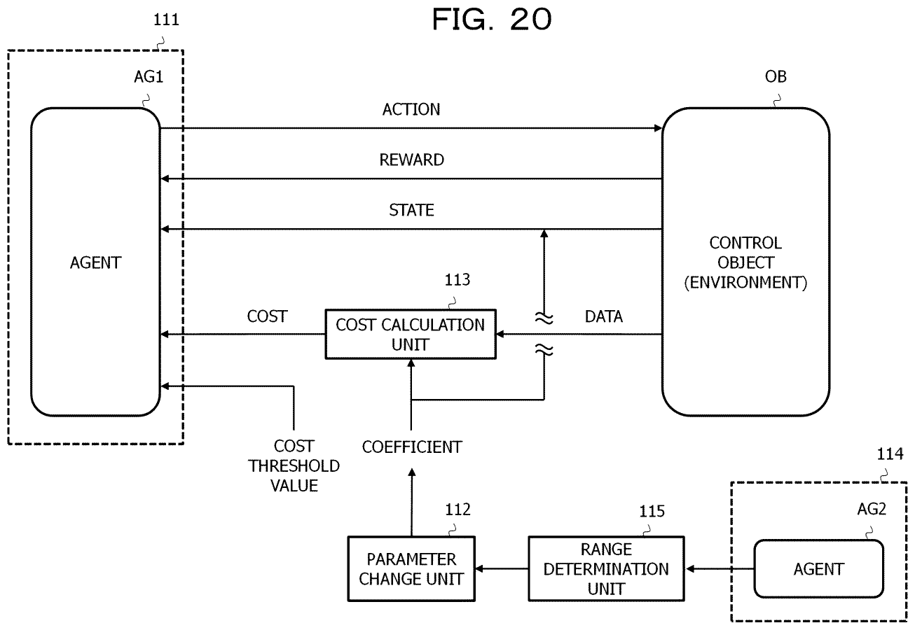

FIG. 20 is a diagram explaining another specific example of the policy training process in the embodiment;

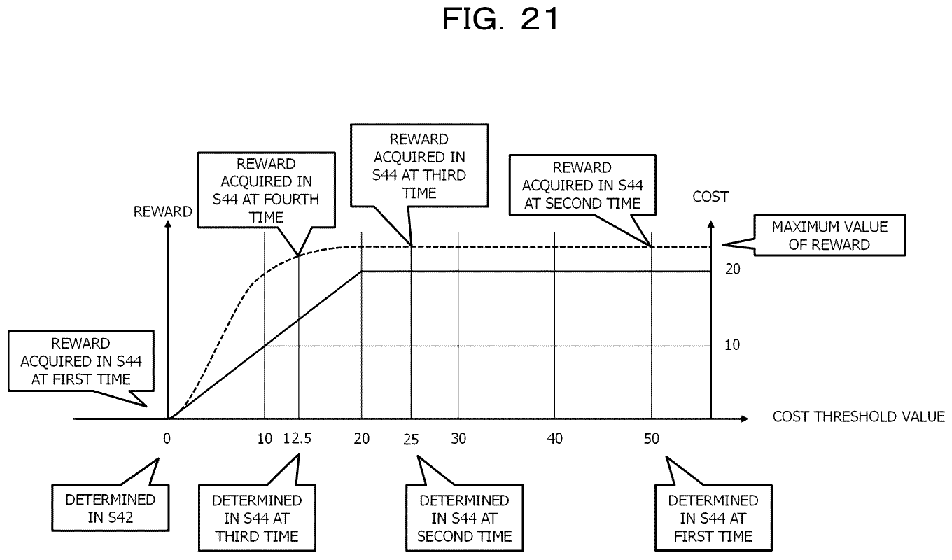

FIG. 21 is a diagram explaining details of the policy training process in the embodiment;

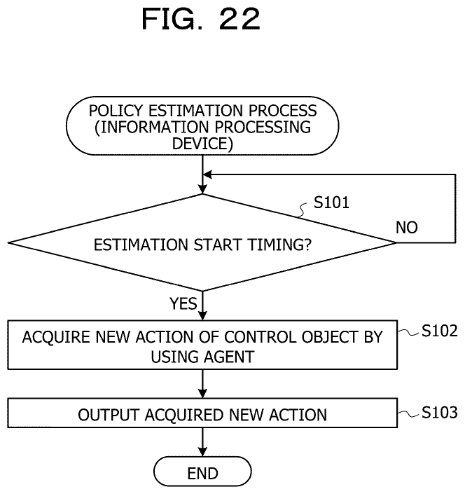

FIG. 22 is a flowchart diagram explaining a policy estimation process according to the embodiment;

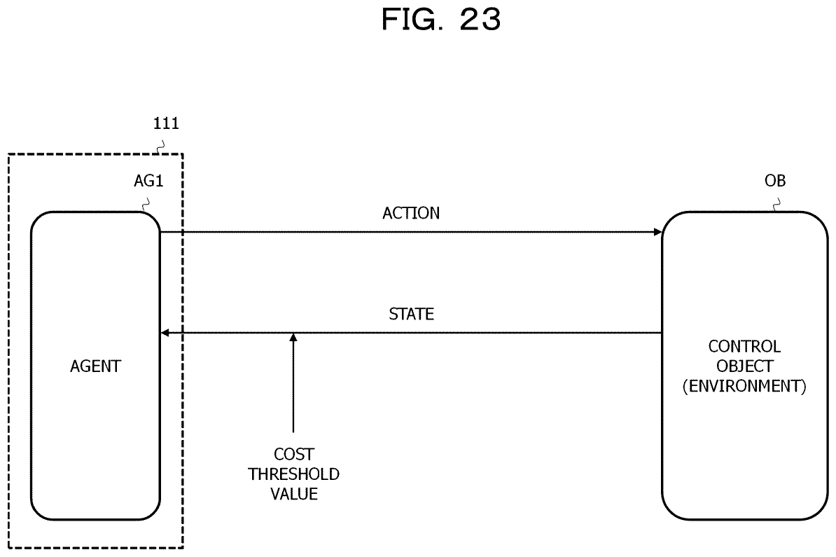

FIG. 23 is a diagram explaining a specific example of the policy estimation process in the embodiment;

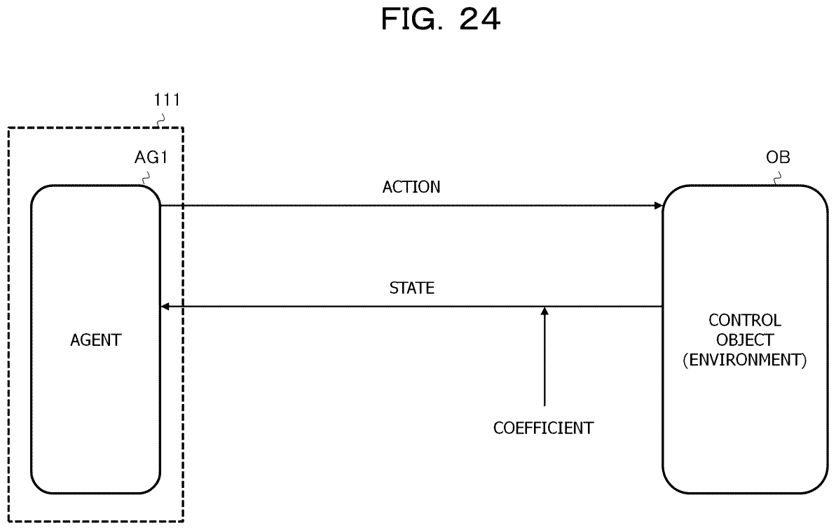

FIG. 24 is a diagram explaining a specific example of the policy estimation process in the embodiment;

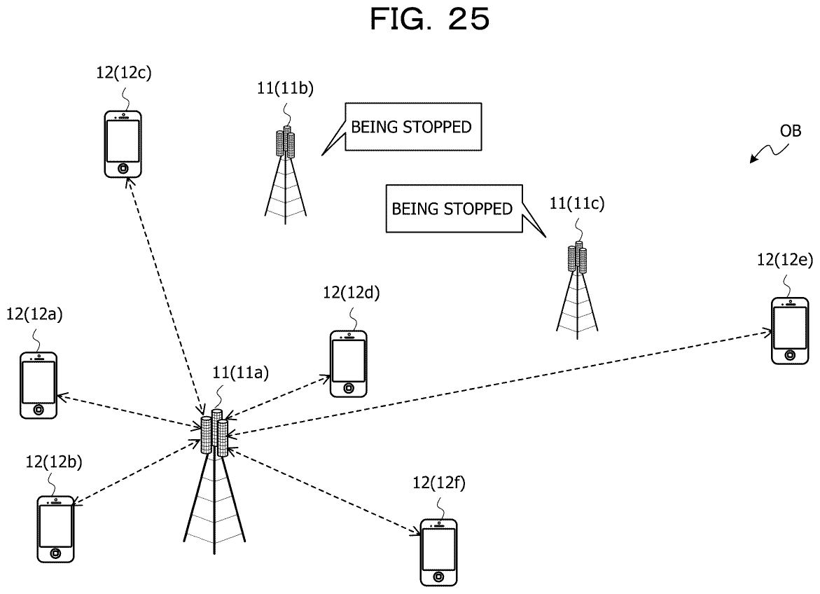

FIG. 25 is a diagram explaining a specific example when a control object OB is activation control for base station devices 11;

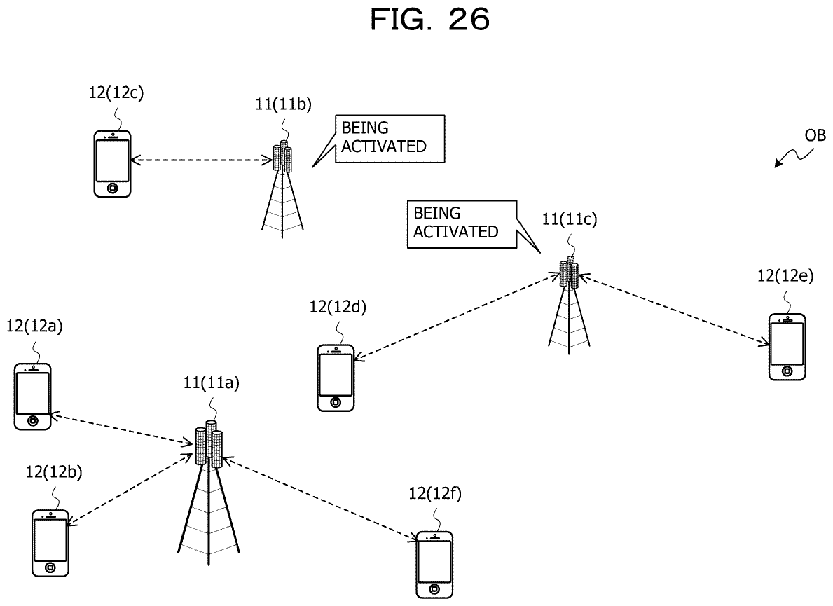

FIG. 26 is a diagram explaining a specific example when the control object OB is activation control for the base station devices 11;

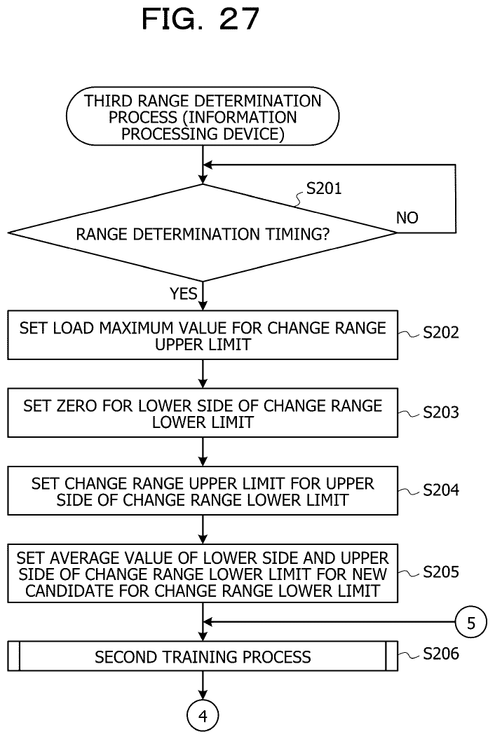

FIG. 27 is a flowchart diagram explaining a range determination process performed in the examples illustrated in FIG. 25 and the like; and

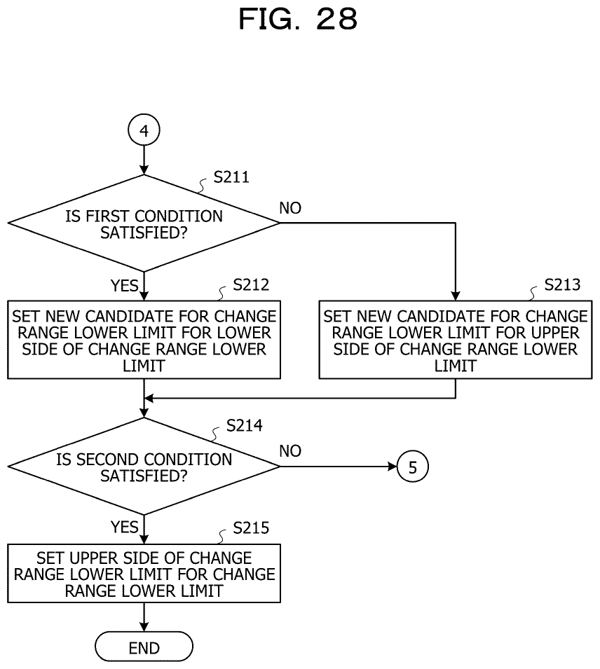

FIG. 28 is a flowchart diagram explaining the range determination process performed in the examples illustrated in FIG. 25 and the like.

### DESCRIPTION OF EMBODIMENTS

The reinforcement learning as mentioned above includes, for example, constrained reinforcement learning (hereinafter, also simply referred to as constrained reinforcement learning) for training an optimal policy while conforming to a constraint condition that a cost from the control object is kept equal to or less than a predefined threshold value (hereinafter, also simply referred to as a constraint condition).

In the constrained reinforcement learning as described above, for example, in a case where training on a policy corresponding to various constraint conditions is performed, different agents have to be trained for each of the constraint conditions. Therefore, in the constrained reinforcement learning as described above, for example, training of the agent may not be efficiently performed in some cases.

Hereinafter, embodiments of techniques capable of efficiently training an agent in constrained reinforcement learning will be described with reference to the drawings. However, such description is not intended to be construed in a limiting sense and does not limit the claimed subject matter. In addition, various changes, substitutions, and modifications may be made without departing from the spirit and scope of the present disclosure. Besides, different embodiments may be appropriately combined.

### EMBODIMENTS

### [Configuration of Wireless Communication System]

First, a configuration of an information processing system 10 will be described. FIG. 1 is a diagram explaining a configuration of the information processing system 10. In addition, FIG. 2 is a diagram explaining constrained reinforcement learning.

As illustrated in FIG. 1, the information processing system 10 includes, for example, an information processing device 1, a storage device 2, and an operation terminal 5.

The storage device 2 is, for example, a hard disk drive (HDD) or a solid state drive (SSD).

The operation terminal 5 is, for example, a personal computer (PC) for an operator to, for example, perform input of relevant information to the information processing device 1, or the like.

The information processing device 1 is, for example, one or more physical machines or virtual machines. Then, the information processing device 1 performs, for example, a process (hereinafter, also referred to as a policy training process) of training an agent AG (hereinafter, also referred to as an agent AG1) corresponding to various constraint conditions through constrained reinforcement learning. Thereafter, for example, the information processing device 1 stores the agent AG1 after training has been performed, in the storage device 2.

For example, as illustrated in FIG. 2, the information processing device 1 repeatedly trains the agent AG1 on a policy (hereinafter, also simply referred to as a policy) for determining an action of a control object OB (hereinafter, also simply referred to as an action), according to, for example, a combination of a state from the control object OB (hereinafter, also simply referred to as a state), a reward from the control object OB (hereinafter, also simply referred to as a reward), and a cost from the control object OB (hereinafter, also simply referred to as a cost), thereby training the agent AG1 on a policy for maximizing the reward while obeying the constraint. For example, the information processing device 1 generates the agent AG1 capable of outputting a next action of the control object OB by, for example, repeatedly inputting and training a combination of a state, a reward, and a cost from the control object OB. Hereinafter, training of the agent AG1 performed in response to one input of a combination of a state, a reward, and a cost from the control object OB will be also simply referred to as a training operation.

Furthermore, for example, in the policy training process, the information processing device 1 changes a parameter regarding the constraint condition (hereinafter, also simply referred to as a parameter), for example, for every predetermined number of times of the training operation. The predetermined number of times may be, for example, one. In addition, the parameter regarding the constraint condition may be, for example, a threshold value of a cost included in the constraint condition (hereinafter, also simply referred to as a cost threshold value). Then, for example, in the policy training process, the information processing device 1 trains the agent AG1 by using the parameter regarding the constraint condition as at least a part of the state and ensuring that the constraint condition is satisfied.

In addition, the information processing device 1 performs a process (hereinafter, also referred to as a policy estimation process) of determining (estimating) a new action of the control object OB (hereinafter, also simply referred to as a new action), for example, by using the agent AG1 (the agent AG1 generated in the policy training process) stored in the storage device 2.

For example, the information processing device 1 acquires a new action output from the agent AG1, for example, in response to an input of a new state from the control object OB (hereinafter, also simply referred to as a new state). Then, for example, the information processing device 1 outputs the acquired new action to the control object OB.

For example, the information processing device 1 according to the present embodiment trains the agent AG1 while, for example, changing the constraint condition, thereby generating the agent AG1 corresponding to various constraint conditions. Therefore, the information processing device 1 may no longer have to separately generate the agents AG1 for each constraint condition, for example.

This may allow the information processing device 1 according to the present embodiment to shorten time involved in training the agent AG1, for example. In addition, for example, the information processing device 1 may be allowed to suppress the usage amount of the storage area of the agent AG1 (such as a storage area in the storage device 2) and also to suppress a cost involved in managing the agent AG1. Furthermore, for example, even in a case where a policy corresponding to a new constraint condition is desired after generation of the agent AG1, the information processing device 1 may no longer have to generate a new agent AG1.

Note that, in a case where the control object OB is a so-called cart-pole problem, the state may be, for example, the position of the cart, the acceleration of the cart, the angle of the pole, or the angular acceleration of the pole, the reward may be, for example, a value that varies depending on whether or not the pole is standing (whether or not the pole falls), the cost may be, for example, a value that grows larger as the cart advances in a predetermined direction, and the action may be, for example, a direction in which the cart is moved (a predetermined direction or a reverse direction of the predetermined direction). For example, in the above example, the reward at a timing when the pole is standing may be “1”, and the reward at a timing when the pole falls may be “0”, as an example.

Here, in the above example, the possibility that the pole falls decreases, for example, as the movable range of the cart is expanded. Therefore, the reward from the control object OB is, for example, a value that grows larger with an increase in cost from the control object OB. Hereinafter, a relationship between the reward, the cost, and the cost threshold value will be described.

### [Relationship Between Reward, Cost, and Cost Threshold Value]

FIG. 3 is a graph illustrating a relationship between the reward, the cost, and the cost threshold value. The vertical axis in the graph illustrated in FIG. 3 corresponds to each of the cost and the reward, and the horizontal axis in the graph illustrated in FIG. 3 corresponds to the cost threshold value. In addition, in the graph, the solid line illustrated in FIG. 3 corresponds to a function indicating the cost (hereinafter, also referred to as a cost function), and the broken line illustrated in FIG. 3 corresponds to a function indicating the reward (hereinafter, also referred to as a reward function). Note that FIG. 3 is a graph illustrating a relationship between the reward, the cost, and the cost threshold value in a case where the control object OB is a cart-pole problem.

For example, in the graph illustrated in FIG. 3, each of the cost and the reward when the cost threshold value is zero or less has zero, as an example.

In addition, in the graph illustrated in FIG. 3, for example, the cost when the cost threshold value is 10 has 10 and exceeds the cost when the cost threshold value is zero. In addition, in the graph illustrated in FIG. 3, for example, the reward when the cost threshold value is 10 exceeds 10 and exceeds the reward when the cost threshold value is zero.

In addition, in the graph illustrated in FIG. 3, for example, the cost when the cost threshold value is 20 has 20 and exceeds the cost when the cost threshold value is 10. In addition, in the graph illustrated in FIG. 3, for example, the reward when the cost threshold value is 20 exceeds 20 and exceeds the reward when the cost threshold value is 10.

In addition, in the graph illustrated in FIG. 3, for example, the cost when the cost threshold value is 30 is 20 and the same as the cost when the cost threshold value is 20. In addition, in the graph illustrated in FIG. 3, for example, the reward when the cost threshold value is 30 exceeds 20, which is the same as the reward when the cost threshold value is 20.

For example, the graph illustrated in FIG. 3 indicates that, for example, in a case where the cost threshold value is strict (in a case where the cost threshold value is zero or less), it is difficult to train a policy that satisfies the constraint condition.

In addition, the graph illustrated in FIG. 3 indicates that, for example, in a case where the cost threshold value is between zero and 20, the reward also grows larger as the cost grows larger.

In addition, the graph illustrated in FIG. 3 indicates that, for example, in a case where the cost threshold value is 20 or more, a policy for attaining the maximum reward at the lowest possible cost is trained, and thus the cost and the reward do not grow larger. Hereinafter, a description will be given using the relationship between the reward, the cost, and the cost threshold value illustrated in FIG. 3.

### [Hardware Configuration of Information Processing System]

Next, a hardware configuration of the information processing system 10 will be described. FIG. 4 is a diagram explaining a hardware configuration of the information processing device 1.

As illustrated in FIG. 4, the information processing device 1 includes, for example, a central processing unit (CPU) 101 as a processor, a memory 102, a communication device (input/output (I/O) interface) 103, and a storage device 104. Each unit is inter-coupled via a bus 105.

The storage device 104 has, for example, a program storage area (not illustrated) that stores a program 110 for performing the policy training process and the policy estimation process (hereinafter, also collectively referred to as a policy training process and the like). In addition, the storage device 104 includes, for example, a storage unit 130 (hereinafter, also referred to as an information storage area 130) that stores information to be used when performing the policy training process and the like. Note that the storage device 104 may be a hard disk drive (HDD) or a solid state drive (SSD), for example.

The CPU 101 executes the program 110 loaded into the memory 102 from the storage device 104, for example, and performs the policy training process.

In addition, the communication device 103 communicates with the operation terminal 5 via a network (not illustrated) such as the Internet, for example.

### [Functions in Information Processing Device]

Next, functions in the information processing device 1 will be described. FIG. 5 is a diagram explaining functions in the information processing device 1. In addition, FIG. 6 is a diagram explaining information stored in the information storage area 130. In addition, FIG. 7 is a diagram explaining the agents AG stored in the storage device 2.

As illustrated in FIG. 5, for example, through organic cooperation between hardware such as the CPU 101 and the memory 102 and the program 110, the information processing device 1 implements respective functions as functions for the policy training process, including a first training unit 111 (hereinafter, also referred to as an agent training unit 111), a parameter change unit 112, a cost calculation unit 113, a second training unit 114, and a range determination unit 115.

In addition, as illustrated in FIG. 5, for example, through organic cooperation between hardware such as the CPU 101 and the memory 102 and the program 110, the information processing device 1 implements respective functions as functions for the policy estimation process, including a policy estimation unit 116 and a policy output unit 117.

In addition, as illustrated in FIG. 6, the information storage area 130 stores, for example, a cost calculation formula 131 and a constraint condition 132. Note that a case where the cost calculation formula 131 and the constraint condition 132 are stored in the information storage area 130 will be described below, but the cost calculation formula 131 and the constraint condition 132 may be stored in the storage device 2, for example.

First, functions in the policy training process will be described.

For example, the first training unit 111 generates the agent AG1 capable of outputting an action (next action) of the control object OB according to an input of a state, a reward, and a cost from the control object OB. Then, as illustrated in FIG. 7, for example, the first training unit 111 stores the generated agent AG1 in the storage device 2. Note that the first training unit 111 may store the agent AG1 in the information storage area 130, for example.

For example, the first training unit 111 causes the agent AG1 to execute the training operation, for example, by inputting a combination of a state, a reward, and a cost acquired from the control object OB to the agent AG1. Then, in this case, the agent AG1 executes the training operation so as to satisfy the constraint condition 132 stored in the information storage area 130, for example, by using the combination of the state, the reward, and the cost input by the first training unit 111. The constraint condition 132 may be, for example, a predefined condition and may be stored in the information storage area 130 in advance by the operator. Furthermore, for example, when causing the agent AG1 to execute the training operation, the first training unit 111 inputs a parameter regarding the constraint condition 132 as at least a part of the state. Thereafter, for example, the first training unit 111 generates the agent AG1 by repeatedly causing the agent AG1 to execute the training operation until the operator inputs information indicating that the training is to be ended, to the information processing device 1.

For example, the parameter change unit 112 changes the parameter regarding the constraint condition 132 stored in the information storage area 130 every time the number of executions of the training operation by the first training unit 111 reaches a predetermined number of times. The parameter regarding the constraint condition 132 may be, for example, the cost threshold value included in the constraint condition 132.

For example, in this case, the parameter change unit 112, for example, randomly changes the parameter regarding the constraint condition 132. Note that a case where the cost threshold value included in the constraint condition 132 is an upper limit threshold value for the cost will be described below, but the cost threshold value included in the constraint condition 132 may be, for example, a lower limit threshold value for the cost.

The cost calculation unit 113 calculates the cost by using the cost calculation formula 131 stored in the information storage area 130, for example. The cost calculation formula 131 may be, for example, a predefined formula and may be stored in the information storage area 130 in advance by the operator.

For example, the cost calculation unit 113 calculates the cost by, for example, substituting data from the control object OB (data used to calculate the cost) into the cost calculation formula 131. When, for example, causing the agent AG1 to execute the training operation, the first training unit 111 uses the cost calculated by the cost calculation unit 113 as one of the inputs to the agent AG1, for example.

Note that the parameter regarding the constraint condition 132 (the parameter to be changed by the parameter change unit 112) may be, for example, a parameter such as a coefficient included in the cost calculation formula 131 stored in the information storage area 130.

For example, the second training unit 114 generates the agent AG (hereinafter, also referred to as an agent AG2) capable of outputting an action (next action) of the control object OB according to an input of a combination of a state, a reward, and a cost from the control object OB. Then, as illustrated in FIG. 7, for example, the second training unit 114 stores the generated agent AG2 in the storage device 2. Note that the second training unit 114 may store the agent AG2 in the information storage area 130, for example.

For example, similarly to the time of generation of the agent AG1, the second training unit 114 may generate the agent AG2 by using, for example, the cost calculation formula 131 and the constraint condition 132 stored in the information storage area 130. Meanwhile, unlike the time of generation of the agent AG1, the agent AG2 may be generated without a change of the parameter regarding the constraint condition 132 made by the parameter change unit 112, for example.

The range determination unit 115 determines a range of parameter change by the parameter change unit 112 (hereinafter, also referred to as a predetermined change range), according to, for example, another cost (hereinafter, also referred to as another cost) when the control object OB performs another action output from the agent AG2 (hereinafter, also simply referred to as another action) in response to an input of another state from the control object OB (hereinafter, also simply referred to as another state).

For example, the parameter change unit 112 changes the parameter regarding the constraint condition 132, for example, within the change range determined by the range determination unit 115.

Next, functions in the policy estimation process will be described.

For example, the policy estimation unit 116 inputs a new state from the control object OB to the agent AG1. Then, the policy estimation unit 116 acquires, for example, a new action (estimation result) of the control object OB output from the agent AG1.

For example, the policy output unit 117 causes the control object OB to perform the new action, by outputting the new action acquired by the policy estimation unit 116 to the control object OB.

### [Outline of Policy Training Process]

Next, an outline of the policy training process according to the embodiment will be described. FIG. 8 is a flowchart diagram explaining an outline of the policy training process according to the embodiment.

As illustrated in FIG. 8, for example, the first training unit 111 waits until a first training start timing has come (NO in S1). The first training start timing may be, for example, a timing at which the operator inputs information indicating that training of the agent AG1 is to be started, to the information storage area 130.

Then, in a case where the first training start timing has come (YES in S1), the first training unit 111 causes the agent AG1 to execute the training operation, for example, with the parameter regarding the constraint condition 132 stored in the information storage area 130 as at least one of the states (S2).

For example, the first training unit 111 causes the agent AG1 to execute the training operation, for example, with the cost threshold value included in the constraint condition 132 as at least one of the states.

For example, in this case, in addition to the state, the reward, and the cost from the control object OB, the first training unit 111 also inputs, for example, the cost threshold value included in the constraint condition 132 to the agent AG1 as one of the states.

Subsequently, the first training unit 111 verifies, for example, whether or not a first training end timing has been reached (S3). The first training end timing may be, for example, a timing at which the operator inputs information indicating that training of the agent AG1 is to be ended, to the information processing device 1. In addition, the first training end timing may be, for example, a timing at which the number of executions of the training operation (the number of executions of the process in S2) has reached a predefined number of times.

As a result, in a case where it is verified that the first training end timing has been reached (YES in S3), the first training unit 111 ends the policy training process, for example.

On the other hand, in a case where it is verified that the first training end timing has not been reached (NO in S3), the parameter change unit 112 verifies, for example, whether or not the number of executions of the training operation has reached a predetermined number of times (S4).

For example, the parameter change unit 112 verifies whether or not, for example, the number of executions of the training operation since the execution of the policy training process was started or the number of executions of the training operation since the process in S5 to be described later was performed last time has reached a predetermined number of times.

As a result, in a case where it is verified that the number of executions of the training operation has reached the predetermined number of times (YES in S4), the parameter change unit 112, for example, changes the parameter regarding the constraint condition 132 stored in the information storage area 130 (S5).

For example, in this case, the parameter change unit 112, for example, randomly changes the cost threshold value included in the constraint condition 132.

Then, for example, after the process in S5 has been performed, the first training unit 111 performs the process in S2 and the subsequent processes again. In addition, for example, even in a case where it is verified that the number of executions of the training operation has not reached the predetermined number of times (NO in S4), the first training unit 111 similarly performs the process in S2 and the subsequent processes again.

For example, the information processing device 1 according to the present embodiment trains the agent AG1 while, for example, changing the constraint condition 132, thereby generating the agent AG1 corresponding to various constraint conditions 132. Therefore, the information processing device 1 may no longer have to separately generate the agents AG1 for each constraint condition 132, for example.

This may allow the information processing device 1 according to the present embodiment to efficiently train the agent AG1 corresponding to various constraint conditions 132, for example.

### [Specific Example (1) of Policy Training Process]

Next, a specific example of the policy training process according to the embodiment will be described. FIGS. 9 to 14 are diagrams explaining a specific example of the policy training process in the embodiment. Hereinafter, a case where the parameter relating to the constraint condition 132 is the cost threshold value included in the constraint condition 132 will be described.

As illustrated in FIG. 9, the cost calculation unit 113 calculates the cost by, for example, substituting data from the control object OB (data used to calculate the cost) into the cost calculation formula 131 stored in the information storage area 130.

For example, the cost calculation formula 131 illustrated in FIG. 10 is a formula indicating that, for example, data (x) from the control object OB is treated as the cost. For example, the cost calculation formula 131 illustrated in FIG. 10 is a formula indicating that, for example, a coefficient by which the data (x) from the control object OB is multiplied is one. Therefore, for example, in a case of using the cost calculation formula 131 illustrated in FIG. 10, the cost calculation unit 113 calculates the cost with data from the control object OB as it is.

Then, for example, the first training unit 111 adds the cost threshold value included in the constraint condition 132 stored in the information storage area 130 to the state from the control object OB.

Furthermore, the first training unit 111 inputs, for example, the state to which the cost threshold value has been added, the reward from the control object OB, and the cost calculated by the cost calculation unit 113 to the agent AG1. Then, in this case, the agent AG1 executes the training operation so as to satisfy the constraint condition 132 stored in the information storage area 130, by using, for example, the state and the like input by the first training unit 111.

For example, the constraint condition 132 illustrated in FIG. 11 is a condition indicating that, for example, the data (x) from the control object OB is 10 or less. For example, the constraint condition 132 illustrated in FIG. 11 is a condition indicating that, for example, the cost threshold value is 10. Therefore, for example, in a case of using the constraint condition 132 illustrated in FIG. 11, the agent AG1 trains a policy adapted such that the data from the control object OB does not exceed 10, for example, in the training operation. Note that, in this case, the constraint condition 132 may be a condition indicating that, for example, the cost calculated by the cost calculation unit 113 is 10 (cost threshold value) or less.

Thereafter, for example, the first training unit 111 outputs an action (next action) of the control object OB determined in the agent AG1 after the training operation has been performed, to the control object OB.

In addition, for example, every time the number of executions of the training operation in the agent AG1 reaches a predetermined number of times, the parameter change unit 112 randomly changes the cost threshold value included in the constraint condition 132 stored in the information storage area 130.

For example, as illustrated in FIG. 12, the parameter change unit 112 changes the constraint condition 132 stored in the information storage area 130 such that the constraint condition 132 indicates that, for example, the data (x) from the control object OB is five or less. For example, in this case, the parameter change unit 112 changes the cost threshold value to five, for example.

Note that, as illustrated in FIG. 13, for example, the first training unit 111 may add a coefficient or the like included in the cost calculation formula 131 stored in the information storage area 130 to the state from the control object OB. For example, the first training unit 111 may use a coefficient or the like included in the cost calculation formula 131 stored in the information storage area 130, for example, as a parameter relating to the constraint condition 132 stored in the information storage area 130.

Then, in this case, for example, the parameter change unit 112 may randomly change the coefficient or the like included in the cost calculation formula 131 stored in the information storage area 130.

For example, as illustrated in FIG. 14, the parameter change unit 112 may change the cost calculation formula 131 stored in the information storage area 130 such that the cost calculation formula 131 indicates that, for example, a value obtained by multiplying the data (x) from the control object OB by two is treated as the cost. For example, in this case, the parameter change unit 112 may change the coefficient by which the data (x) from the control object OB is multiplied, to two, for example.

### [Details of Policy Training Process]

Next, details of the policy training process according to the embodiment will be described. FIGS. 15 to 18 are flowchart diagrams explaining details of the policy training process according to the embodiment. In addition, FIGS. 19 to 21 are diagrams explaining details of the policy training process in the embodiment.

### [Second Training Process]

First, a process of generating the agent AG2 used to determine the change range of the parameter regarding the constraint condition 132 (hereinafter, also referred to as a second training process) in the policy training process will be described. FIG. 15 is a flowchart diagram explaining the second training process.

As illustrated in FIG. 15, for example, the second training unit 114 waits until a second training start timing has come (NO in S11). The second training start timing may be, for example, a timing at which the operator inputs information indicating that training of the agent AG2 is to be started, to the information storage area 130.

Then, in a case where the second training start timing has come (YES in S11), the second training unit 114, for example, executes the training operation (S12).

For example, the second training unit 114 trains the agent AG2 by inputting, for example, a combination of a state, a reward, and a cost from the control object OB.

Subsequently, the second training unit 114 verifies, for example, whether or not a second training end timing has been reached (S13). The second training end timing may be, for example, a timing at which the operator inputs information indicating that training of the agent AG2 is to be ended, to the information processing device 1. In addition, the second training end timing may be, for example, a timing at which the number of executions of the training operation (the number of executions of the process in S12) has reached a predefined number of times.

As a result, in a case where it is verified that the second training end timing has not been reached (NO in S13), the second training unit 114 performs, for example, the process in S12 and the subsequent processes again.

On the other hand, in a case where it is verified that the second training end timing has been reached (YES in S13), the second training unit 114 ends the second training process, for example.

### [First Range Determination Process]

Next, a process of determining a parameter change range, using the agent AG2 (hereinafter, also referred to as a range determination process or a first range determination process) in the policy training process will be described. FIG. 16 is a flowchart diagram explaining the first range determination process.

As illustrated in FIG. 16, for example, the range determination unit 115 waits until a range determination timing has come (NO in S21). The range determination timing may be, for example, timing at which the operator inputs information indicating that the parameter change range is to be determined, to the information storage area 130.

Then, in a case where the range determination timing has come (YES in S21), the range determination unit 115 determines a change range of the parameter regarding the constraint condition 132, for example, from the training result of the agent AG2 stored in the storage device 2 (S22).

For example, in this case, the range determination unit 115 acquires a new action of the control object OB output from the agent AG2, for example, in response to an input of a new state from the control object OB. For example, the range determination unit 115 acquires a new action of the control object OB, for example, by performing the policy estimation process using the agent AG2. Then, for example, by causing the control object OB to perform the acquired new action, the range determination unit 115 calculates a new cost from the control object OB (hereinafter, also simply referred to as a new cost). Thereafter, the range determination unit 115 determines a parameter change range, for example, according to the calculated new cost.

For example, in a case where the maximum value of the new cost is smaller than 30 when an upper limit of the cost threshold value included in the constraint condition 132 stored in the information storage area 130 (an upper limit of the cost threshold value included in the constraint condition 132 at the time of generating the agent AG2) is 30, the range determination unit 115 verifies that the upper limit of the change range of the cost threshold value when generating the agent AG1 is allowed to be lowered, for example. For example, in a case where the maximum value of the calculated new cost is 20, the range determination unit 115, for example, adjusts the upper limit of the change range of the cost threshold value when generating the agent AG1 to 20, for example.

In addition, in a case where the minimum value of the new cost is larger than 10 when a lower limit of the cost threshold value included in the constraint condition 132 stored in the information storage area 130 (a lower limit of the cost threshold value included in the constraint condition 132 at the time of generating the agent AG2) is 10, the range determination unit 115 verifies that the lower limit of the change range of the cost threshold value when generating the agent AG1 is allowed to be raised, for example. For example, in a case where the minimum value of the calculated new cost is 20, the range determination unit 115, for example, adjusts the lower limit of the change range of the cost threshold value when generating the agent AG1 to 20, for example.

This may allow the information processing device 1 according to the present embodiment to shorten time involved in generating the agent AG1, for example.

Note that the range determination unit 115 may perform another range determination process for determining the change range of the cost threshold value without using the agent AG2 (hereinafter, also referred to as a range determination process without using the agent AG2), for example.

For example, when the maximum value of the cost after the whole or a part of an action that may be performed in the control object OB has been repeated is 20 in a case where, for example, the cost threshold value included in the constraint condition 132 stored in the information storage area 130 is 30, the range determination unit 115 may adjust the upper limit of the change range of the cost threshold value when generating the agent AG1 to 20.

In addition, when the maximum value of the cost after an action that is not likely to meet the constraint condition 132 has been repeated is 20 in a case where, for example, the cost threshold value included in the constraint condition 132 stored in the information storage area 130 is 30, the range determination unit 115 may adjust the upper limit of the change range of the cost threshold value when generating the agent AG1 to 20.

In addition, when the maximum value of the cost after an action that is highly likely to meet the constraint condition 132 has been repeated is 20 in a case where, for example, the cost threshold value included in the constraint condition 132 stored in the information storage area 130 is 30, the range determination unit 115 may adjust the upper limit of the change range of the cost threshold value when generating the agent AG1 to 20.

In addition, for example, in a case where there is an operational constraint condition in the control object OB, the range determination unit 115 may determine the change range of the cost threshold value so as to satisfy the operational constraint condition.

### [First Training Process]

Next, a process of generating the agent AG1 (hereinafter, also referred to as a first training process) in the policy training process will be described. FIG. 17 is a flowchart diagram explaining the first training process.

As illustrated in FIG. 17, for example, the first training unit 111 waits until the first training start timing has come (NO in S31).

Then, in a case where the training start timing has come (YES in S31), the first training unit 111 executes the training operation, for example, with the parameter relating to the constraint condition 132 stored in the information storage area 130 as at least one of the states (S32).

For example, in this case, the first training unit 111 executes the training operation by, for example, inputting the cost threshold value included in the constraint condition 132 to the agent AG1 as at least one of the states.

Subsequently, the first training unit 111 verifies, for example, whether or not the first training end timing has been reached (S33).

As a result, in a case where it is verified that the first training end timing has been reached (YES in S33), the first training unit 111 ends the first training process, for example.

On the other hand, in a case where it is verified that the training end timing has not been reached (NO in S33), the parameter change unit 112 verifies, for example, whether or not the number of executions of the training operation has reached a predetermined number of times (S34).

For example, the parameter change unit 112 verifies whether or not, for example, the number of executions of the training operation since the execution of the first training process was started or the number of executions of the training operation since the process in S35 to be described later was performed last time has reached a predetermined number of times.

As a result, in a case where it is verified that the number of executions of the training operation has reached the predetermined number of times (YES in S34), the parameter change unit 112, for example, changes the parameter regarding the constraint condition 132 stored in the information storage area 130 within the parameter change range determined in the process in S24 (S35).

For example, in this case, the parameter change unit 112, for example, randomly changes the parameter regarding the constraint condition 132 within the parameter change range determined in the process in S24.

Then, for example, after the process in S35 has been performed, the first training unit 111 performs the process in S32 and the subsequent processes again. In addition, for example, even in a case where it is verified that the number of executions of the training operation has not reached the predetermined number of times (NO in S34), the first training unit 111 similarly performs the process in S32 and the subsequent processes again.

For example, the information processing device 1 according to the present embodiment, for example, changes the parameter relating to the constraint condition 132 stored in the information storage area 130 within the parameter change range determined in the first range determination process.

This may allow the information processing device 1 according to the present embodiment to more efficiently train the agent AG1 corresponding to various constraint conditions 132, for example.

### [Specific Example (2) of Policy Training Process]

Next, another specific example of the policy training process according to the embodiment will be described. FIGS. 19 and 20 are diagrams explaining another specific example of the policy training process in the embodiment. Differences from FIGS. 9 and 13 will be described below.

As illustrated in FIG. 19, for example, the range determination unit 115 determines a change range of the cost threshold value included in the constraint condition 132 stored in the information storage area 130 by using the agent AG2 generated by the second training unit 114.

Then, for example, every time the number of executions of the training operation reaches a predetermined number of times, the parameter change unit 112 changes the cost threshold value included in the constraint condition 132 stored in the information storage area 130 within the change range of the cost threshold value determined by the range determination unit 115.

Note that, as illustrated in FIG. 20, for example, the range determination unit 115 may determine a change range of a coefficient or the like included in the cost calculation formula 131 stored in the information storage area 130 by using the agent AG2 generated by the second training unit 114.

Then, for example, every time the number of executions of the training operation reaches a predetermined number of times, the parameter change unit 112 may change the coefficient or the like included in the cost calculation formula 131 stored in the information storage area 130 within the change range of the coefficient or the like determined by the range determination unit 115.

### [Second Range Determination Process]

Next, another range determination process (hereinafter, also referred to as a second range determination process) will be described. FIG. 18 is a flowchart diagram explaining the second range determination process. In addition, FIG. 21 is a diagram explaining the second range determination process. Note that the second range determination process is, for example, a process performed instead of the first range determination process. In addition, the second range determination process includes, for example, the second training process as will be described later.

First, the process in S41, the process in S42, and the processes in S43 to S45 performed at the first time will be described.

As illustrated in FIG. 18, for example, the range determination unit 115 waits until the range determination timing has come (NO in S41).

Then, in a case where the range determination timing has come (YES in S41), the range determination unit 115, for example, determines the parameter (initial value) regarding the constraint condition 132 stored in the information storage area 130 (S42).

For example, as illustrated in FIG. 21, the range determination unit 115 determines, for example, “0” that is the lowest value in the range of values selectable as the cost threshold value included in the constraint condition 132, as a parameter (initial value) regarding the constraint condition 132. Note that the range of values selectable as the cost threshold value included in the constraint condition 132 may be determined in advance by the operator, for example.

Subsequently, by executing, for example, the second training process, the second training unit 114 generates the agent AG2, using the constraint condition 132 corresponding to the parameter determined in the process in S42 (S43).

Thereafter, the range determination unit 115 determines a parameter (next parameter) regarding the constraint condition 132 from, for example, the training result of the agent AG2 generated in the immediately preceding process in S43 (S44).

For example, as illustrated in FIG. 21, in the process in S44 at the first time, the range determination unit 115 determines, for example, “50” that is the highest value in the range of values selectable as the cost threshold value included in the constraint condition 132, as a parameter (initial value) regarding the constraint condition 132.

Thereafter, the range determination unit 115 verifies, for example, whether or not an end condition of the second range determination process (hereinafter, also simply referred to as an end condition) has been achieved (S45). The end condition may be, for example, that a difference between the value indicated by the parameter determined in the process in S44 at this time and the value indicated by the parameter determined in the process in S44 at the previous time is equal to or less than a predetermined value.

As a result, in a case where it is verified that the end condition has not been achieved (NO in S45), the range determination unit 115 performs, for example, the process in S43 and the subsequent processes again.

Next, the processes in S43 to S45 performed at the second time will be described.

For example, the second training unit 114 generates the agent AG2 again using the constraint condition 132 corresponding to the parameter determined in the immediately preceding process in S44 (S43).

For example, in the second range determination process, unlike the first range determination process, for example, the parameter change range is specified by using each of a plurality of agents AG2.

Then, the range determination unit 115 determines a parameter (next parameter) regarding the constraint condition 132 from, for example, the training result of the agent AG2 generated in the immediately preceding process in S43 (S44).

For example, as illustrated in FIG. 21, the range determination unit 115 determines, as a parameter regarding the constraint condition 132, for example, “25” that is an average value of “0” that is the value indicated by the parameter determined in the process in S42 and “50” that is the value indicated by the parameter determined in the process in S44 at the first time.

Thereafter, the range determination unit 115 verifies, for example, whether or not the end condition has been achieved (S45).

As a result, in a case where it is verified that the end condition has not been achieved (NO in S45), the range determination unit 115 performs, for example, the process in S43 and the subsequent processes again.

Next, the processes in S43 to S45 performed at the third time will be described.

For example, the second training unit 114 generates the agent AG2 again using the constraint condition 132 corresponding to the parameter determined in the immediately preceding process in S44 (S43).

Then, the range determination unit 115 determines a parameter (next parameter) regarding the constraint condition 132 from, for example, the training result of the agent AG2 generated in the immediately preceding process in S43 (S44).

For example, the range determination unit 115 acquires a new action of the control object OB output from the agent AG2 (the agent AG2 generated in the immediately preceding process in S43), for example, in response to an input of a new state from the control object OB. For example, the range determination unit 115 acquires a new action of the control object OB, for example, by performing the policy estimation process using the agent AG2 generated in the immediately preceding process in S43. Then, for example, by causing the control object OB to perform the acquired new action, the range determination unit 115 acquires a new reward from the control object OB (hereinafter, also simply referred to as a new reward). Thereafter, the range determination unit 115 determines a parameter (next parameter) from, for example, each of new rewards acquired in the process in S44 performed up to this time.

Furthermore, for example, as illustrated in FIG. 21, in a case where, for example, the reward acquired in the process in S44 at the second time and the reward acquired in the process in S44 at the third time are the same, the range determination unit 115 verifies that there is a value capable of attaining the same reward as the reward acquired in the process in S44 at the third time, as a value larger than the value indicated by the parameter determined in the process in S42 but smaller than the value indicated by the parameter determined in the process in S44 at the second time.

Therefore, in this case, for example, the range determination unit 115 determines a value larger than “0”, which is the value indicated by the parameter determined in the process in S42, but smaller than “25”, which is the value indicated by the parameter determined in the process in S44 at the second time, as a parameter (next parameter) regarding the constraint condition 132. For example, in this case, the range determination unit 115 determines, as a parameter regarding the constraint condition 132, for example, “12.5” that is an average value of “0” that is the value indicated by the parameter determined in the process in S42 and “25” that is the value indicated by the parameter determined in the process in S44 at the second time.

As a result, in a case where it is verified that the end condition has not been achieved (NO in S45), the range determination unit 115 performs, for example, the process in S43 and the subsequent processes again.

Next, the processes in S43 to S45 performed at the fourth time will be described.

For example, the second training unit 114 generates the agent AG2 again using the constraint condition 132 corresponding to the parameter determined in the immediately preceding process in S44 (S43).

Then, the range determination unit 115 determines a parameter (next parameter) regarding the constraint condition 132 from, for example, the training result of the agent AG2 generated in the immediately preceding process in S43 (S44).

For example, in the range determination unit 115, as illustrated in FIG. 21, in a case where, for example, the reward acquired in the process in S44 at the fourth time is smaller than the reward acquired in the process in S44 at the third time, the range determination unit 115 verifies that there is a value capable of attaining the same reward as the reward acquired in the process in S44 at the third time, as a value larger than the value indicated by the parameter determined in the process in S44 at the third time but smaller than the value indicated by the parameter determined in the process in S44 at the second time.

Therefore, in this case, for example, the range determination unit 115 determines a value larger than “12.5”, which is the value indicated by the parameter determined in the process in S44 at the third time, but smaller than “25”, which is the value indicated by the parameter determined in the process in S44 at the second time, as a parameter (next parameter) regarding the constraint condition 132. For example, in this case, the range determination unit 115 determines, as a parameter regarding the constraint condition 132, for example, “18.75” that is an average value of “25” that is the value indicated by the parameter determined in the process in S44 at the second time and “12.5” that is the value indicated by the parameter determined in the process in S44 at the third time.

Thereafter, the range determination unit 115 verifies, for example, whether or not the end condition has been achieved (S45).

As a result, in a case where it is verified that the end condition has not been achieved (NO in S45), the range determination unit 115 performs, for example, the process in S43 and the subsequent processes again.

Note that, in the process in S44 at the fifth and subsequent times, the range determination unit 115 may perform a process similar to the process in S44 at the third time in a case where the reward acquired in the process in S44 at the previous time and the reward acquired in the process in S44 at this time are the same and may perform a process similar to the process in S44 at the fourth time in a case where the reward acquired in the process in S44 at this time is smaller than the reward acquired in the process in S44 at the previous time, for example.

On the other hand, in a case where it is verified that the end condition has been achieved (YES in S45), the range determination unit 115, for example, determines a change range of the parameter relating to the constraint condition 132 (S46).

For example, the range determination unit 115 specifies, for example, a value of the parameter when the reward acquired in the process in S44 has the maximum value. Then, for example, the range determination unit 115 determines a minimum value (a value near “20” in the example illustrated in FIG. 21) among the specified values, as the upper limit of the change range of the parameter relating to the constraint condition 132.

For example, by repeatedly performing the process in S44 in a period until, for example, the end condition is achieved, the range determination unit 115 gradually narrows the range including the parameter having the minimum new cost from the control object OB among the parameters that maximize the new reward from the control object OB. Then, the range determination unit 115 determines the change range of the parameter regarding the constraint condition 132 by using, for example, a range narrowed until the end condition is achieved.

This may allow the information processing device 1 to specify the change range of the parameter regarding the constraint condition 132 regardless of the complexity of the cost function, for example.

Note that, in the above example, a case where the parameter regarding the constraint condition 132 is determined by comparing the reward acquired in the process in S44 at this time with the reward acquired in the process in S44 at the previous time has been described, but this is not restrictive. For example, in the process in S44, the range determination unit 115 may acquire a new cost from the control object OB by, for example, causing the control object OB to perform a new action. Then, for example, in a case where the new cost fulfills the constraint condition 132, the range determination unit 115 may determine a value smaller than the value indicated by the parameter determined in the process in S44 at the previous time, as a parameter (next parameter) regarding the constraint condition 132. In addition, for example, in a case where the new cost does not fulfill the constraint condition 132, the range determination unit 115 may determine a value larger than the value indicated by the parameter determined in the process in S44 at the previous time, as a parameter (next parameter) regarding the constraint condition 132.

In addition, in the above example, a case where the upper limit of the change range of the parameter relating to the constraint condition 132 is determined has been described, but this is not restrictive. For example, the range determination unit 115 may determine, for example, the lower limit of the change range of the parameter relating to the constraint condition

### [Policy Estimation Process]

Next, a policy estimation process according to the embodiment will be described. FIG. 22 is a flowchart diagram explaining the policy estimation process according to the embodiment.

As illustrated in FIG. 22, for example, the policy estimation unit 116 waits until an estimation start timing has come (NO in S101). The estimation start timing may be, for example, a timing at which the operator inputs information indicating that the estimation of a policy is to be started, to the information storage area 130.

Then, in a case where the estimation start timing has come (YES in S101), the policy estimation unit 116 acquires, for example, a new action of the control object OB output from the agent AG1 in response to an input of a new state from the control object OB (S102).

Thereafter, the policy output unit 117 outputs, for example, the new action acquired in the process in S102 to the control object OB (S103).

### [Specific Example of Policy Estimation Process]

Next, a specific example of the policy estimation process according to the embodiment will be described. FIGS. 23 and 24 are diagrams explaining a specific example of the policy estimation process in the embodiment.

As illustrated in FIG. 23, for example, the policy estimation unit 116 adds a cost threshold value included in the constraint condition 132 stored in the information storage area 130 to a new state from the control object OB.

Then, for example, the policy estimation unit 116 outputs, to the control object OB, a new action of the control object OB output from the agent AG1 in response to an input of the new state to which the cost threshold value has been added.

Note that, as illustrated in FIG. 24, for example, the policy estimation unit 116 may add a coefficient or the like included in the cost calculation formula 131 stored in the information storage area 130 to the new state from the control object OB.

Then, for example, the policy estimation unit 116 may output, to the control object OB, a new action of the control object OB output from the agent AG1 in response to an input of the new state to which a coefficient or the like has been added.

As described above, the information processing device 1 according to the present embodiment changes the parameter regarding the constraint condition 132 for every predetermined number of times of the training operation in the policy training process, for example. Then, for example, the information processing device 1 trains the agent AG1 by using the parameter regarding the constraint condition 132 as at least a part of the state and ensuring that the constraint condition 132 is satisfied.

In addition, the information processing device 1 according to the present embodiment acquires a new action of the control object OB output from the agent AG1, for example, in response to an input of a new state from the control object OB. Then, for example, the information processing device 1 outputs the acquired new action to the control object OB.

For example, the information processing device 1 according to the present embodiment may be allowed to generate the agent AG1 corresponding to various constraint conditions 132, by training the agent AG1 while, for example, changing the constraint condition 132. Therefore, the information processing device 1 may no longer have to generate the agents AG1 for each constraint condition 132, for example.

This may allow the information processing device 1 according to the present embodiment to shorten time involved in training the agent AG1, for example. In addition, for example, the information processing device 1 may be allowed to suppress the usage amount of the storage area of the agent AG1 (such as a storage area in the storage device 2) and also to suppress a cost involved in managing the agent AG1. Furthermore, for example, even in a case where a policy corresponding to the new constraint condition 132 is desired after generation of the agent AG1, the information processing device 1 may no longer have to generate a new agent AG1.

Note that, in the policy training process and the like in the present embodiment, for example, the control object OB may be used for activation control for a base station device. Hereinafter, a case where the control object OB is used for activation control for a base station device will be described.

[Specific Example when Control Object is Activation Control for Base Station Device]

FIGS. 25 and 26 are diagrams explaining a specific example when the control object OB is activation control for base station devices 11.

In the example illustrated in FIG. 25 and the like, the control object OB includes, for example, a base station device 11a that is a macro base station (MBS), a base station device 11b that is a small base station (SBS), and a base station device 11c that is an SBS. Then, in the example illustrated in FIG. 25 and the like, at least one of the base station devices 11a, 11b, and 11c performs wireless communication with, for example, terminal devices 12a, 12b, 12c, 12d, 12e, and 12f. Hereinafter, the base station devices 11a, 11b, and 11c will also be collectively referred to simply as base station devices 11. In addition, hereinafter, the terminal devices 12a, 12b, 12c, 12d, 12e, and 12f will also be collectively referred to simply as terminal devices 12.

For example, in the example illustrated in FIG. 25, for example, the base station devices 11b and 11c are stopped. Therefore, in the example illustrated in FIG. 25, each of the terminal devices 12a, 12b, 12c, 12d, 12e, and 12f performs wireless communication with the base station device 11a.

On the other hand, in the example illustrated in FIG. 26, for example, the base station devices 11b and 11c are activated. Therefore, in the example illustrated in FIG. 26, unlike the example illustrated in FIG. 25, the terminal device 12c performs wireless communication with the base station device 11b, and each of the terminal devices 12d and 12e performs wireless communication with the base station device 11c.

Accordingly, in the example illustrated in FIG. 25, for example, as compared with the case in the example illustrated in FIG. 26, the load in the base station device 11a grows larger, while the power consumption amount of the base station devices 11 as a whole is suppressed. For example, in the example illustrated in FIG. 26, for example, as compared with the case in the example illustrated in FIG. 25, the load in the base station device 11a becomes smaller, while the power consumption of the base station devices 11 as a whole is increased.

Here, the maximum value of the load (hereinafter, also referred to as a load maximum value) in each of the base station devices 11a, 11b, and 11c fluctuates depending on, for example, the amount of traffic or the like with each terminal device 12. A threshold value of the load (hereinafter, also referred to as a load threshold value) in each of the base station devices 11a, 11b, and 11c is a parameter relating to a constraint condition.

Thus, the information processing device 1 according to the present embodiment determines a policy for each load threshold value by using the agent AG1 generated in the policy training process, for example.

For example, in this case, the information processing device 1 according to the present embodiment trains the agent AG1 by, for example, assuming the state as a predicted amount of traffic for the next 30 minutes or the load of each base station device 11, assuming the reward as exp (the total sum of the power consumption amounts in all the base station devices 11 for the last 30 minutes), assuming the cost as a value calculated by the cost calculation formula 131 indicated in following Formula (1), assuming the action as activation control for each base station device 11 for the next 30 minutes, and assuming the constraint condition 132 as cost<=1 (cost threshold value=1).

$$if ( Load Maximum Value > Load Threshold Value ) \{ \qquad Formula ( 1 )$$

$$Cost = 1000 + 1000 * ( Load Maximum Value - Load Threshold Value )$$

$$\} else \{$$

$$Cost = 0$$

Note that, in above Formula (1), the load maximum value is, for example, the maximum value of the load in each of the base station devices 11a, 11b, and 11c. For example, above Formula 1 indicates that the cost increases, for example, in a case where the load maximum value exceeds the load threshold value.

### [Range Determination Process Performed in Examples Illustrated in FIG. 25, Etc.]

Next, the range determination process performed in the examples illustrated in FIGS. 25 and 26 will be described. FIGS. 27 and 28 are flowchart diagrams explaining the range determination process performed in the examples illustrated in FIG. 25 and the like. Hereinafter, a description will be given assuming that the parameter relating to the constraint condition 132 is the load threshold value included in the cost calculation formula 131. In addition, hereinafter, the upper limit of the change range of the load threshold value will be also simply referred to as a change range upper limit, and the lower limit of the change range of the parameter will be also simply referred to as a change range lower limit. Note that, in the example illustrated in FIG. 27 and the like, the process in S202 corresponds to the range determination process without using the agent AG2, and each of the process in S203 and the subsequent processes corresponds to the second range determination process. In addition, each of the change range upper limit, the change range lower limit, a candidate for the change range lower limit on an upper side (hereinafter, also simply referred to as an upper side of the change range lower limit), a candidate for the change range lower limit on a lower side (hereinafter, also simply referred to as a lower side of the change range lower limit), and a newly obtained candidate for the change range lower limit (hereinafter, also referred to as a new candidate for the change range lower limit) may be stored in the information storage area 130, for example.

As illustrated in FIG. 27, for example, the range determination unit 115 waits until the range determination timing has come (NO in S201).

Then, in a case where the range determination timing has come (YES in S201), the range determination unit 115 sets the load maximum value for the change range upper limit, for example (S202). Note that the load maximum value here may be, for example, a load maximum value after an action that is not likely to meet the constraint condition 132 has been repeated in the control object OB.

Next, the range determination unit 115 sets zero for the lower side of the change range lower limit, for example (S203).

In addition, for example, the range determination unit 115 sets a value indicated by the change range upper limit set in the process in S202 for the upper side of the change range lower limit (S204).

Subsequently, for example, the range determination unit 115 sets an average value of the value indicated by the lower side of the change range lower limit set in the process in S203 and the value indicated by the upper side of the change range lower limit set in the process in S204 for the new candidate for the change range lower limit (S205).

Furthermore, for example, the second training unit 114 generates the agent AG2, using the constraint condition 132 when the new candidate for the change range lower limit set in the process in S205 is treated as the load threshold value (S206).

Then, as illustrated in FIG. 28, for example, the range determination unit 115 verifies whether or not the agent AG2 generated in the process in S206 satisfies a first condition (S211).

For example, the range determination unit 115 acquires an action of the control object OB output from the agent AG2 (the agent AG2 generated in the immediately preceding process in S206), for example, in response to an input of a state from the control object OB. Then, the range determination unit 115 acquires the load maximum value from the control object OB, for example, by causing the control object OB to perform the acquired action. Thereafter, for example, in a case where the acquired load maximum value is smaller than the sum of the load threshold value and a predefined margin, the range determination unit 115 verifies that the agent AG2 generated in the process in S206 satisfies the first condition.

As a result, in a case where it is verified that the agent AG2 generated in the process in S206 satisfies the first condition (YES in S211), the range determination unit 115, for example, sets a value indicated by the new candidate for the change range lower limit set in the process in S205 for the lower side of the change range lower limit (S212).

On the other hand, in a case where it is verified that the agent AG2 generated in the process in S206 does not satisfy the first condition (NO in S211), the range determination unit 115, for example, sets a value indicated by the new candidate for the change range lower limit set in the process in S205 for the upper side of the change range lower limit (S213).

Thereafter, for example, the range determination unit 115 verifies whether or not the relationship between the value indicated by the lower side of the change range lower limit set in the process in S212 and the value indicated by the upper side of the change range lower limit set in the process in S213 satisfies a second condition (S214).

In a case where, for example, the difference between the value indicated by the lower side of the change range lower limit set in the process in S212 and the value indicated by the upper side of the change range lower limit set in the process in S213 is smaller than a predefined threshold value, the range determination unit 115 verifies that the relationship between the value indicated by the lower side of the change range lower limit set in the process in S212 and the value indicated by the upper side of the change range lower limit set in the process in S213 satisfies the second condition, for example.

As a result, in a case where it is verified that the relationship between the value indicated by the lower side of the change range lower limit set in the process in S212 and the value indicated by the upper side of the change range lower limit set in the process in S213 does not satisfy the second condition (NO in S214), the second training unit 114 and the range determination unit 115 perform the process in S206 and the subsequent processes again, for example.

On the other hand, in a case where it is verified that the relationship between the value indicated by the lower side of the change range lower limit set in the process in S212 and the value indicated by the upper side of the change range lower limit set in the process in S213 satisfies the second condition (YES in S214), the range determination unit 115, for example, sets the value indicated by the upper side of the change range lower limit set in the process in S213 for the change range lower limit (S215).

This may allow the information processing device 1 according to the present embodiment to specify, for example, a range from the change range lower limit to the change range upper limit, as a change range of the parameter relating to the constraint condition 132 (the load threshold value included in the cost calculation formula 131).

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A policy training device that trains, through first reinforcement learning, a first agent configured to output a first action of a control object according to an input of a first state of the control object, the policy training device comprising:
a memory; and
processor circuitry coupled to the memory and configured to:
change a first parameter regarding a constraint condition in the first reinforcement learning for every predetermined number of times of a training operation in the first reinforcement learning; and
train the first agent by using the first parameter as at least a part of the first state and by ensuring that the constraint condition is satisfied.

2. The policy training device according to claim 1, wherein the processor circuitry is configured to randomly change the first parameter within a predetermined change range.

3. The policy training device according to claim 1,
wherein the processor circuitry is further configured to;
acquire a cost from the first state of the control object,
wherein the constraint condition is the constraint condition related to the cost, and
the first parameter is a threshold value of the cost.

4. The policy training device according to claim 1,
wherein the processor circuitry is further configured to:
acquire a cost from the first state of the control object,
wherein the constraint condition is the constraint condition related to the cost, and
the first parameter is used to acquire the cost.

5. The policy training device according to claim 1,
wherein the processor circuitry is further configured to:
determine a change range of the first parameter, according to a cost when the control object performs a second action output from a second agent trained through second reinforcement learning.

6. The policy training device according to claim 1,
wherein the processor circuitry is further configured to acquire a third action of the control object output from the first agent in response to an input of a second state of the control object; and
output the acquired third action,
wherein the processor circuitry is configured to input a second parameter regarding the constraint condition to the first agent as at least the part of the second state.

7. A policy training method of a policy training device that trains, through first reinforcement learning, a first agent configured to output a first action of a control object according to an input of a first state of the control object, the policy training method for causing a computer to execute a process, the process comprising:
changing a first parameter regarding a constraint condition in the first reinforcement learning for every predetermined number of times of a training operation in the first reinforcement learning; and
training the first agent by using the first parameter as at least a part of the first state and by ensuring that the constraint condition is satisfied.

8. The policy training method according to claim 7, the process further comprising:
determining a change range of the first parameter, according to a cost when the control object performs a second action output from a second agent trained through second reinforcement learning.

9. A communication system comprising:
a base station device; and
a policy training device configured to train, through first reinforcement learning, a first agent configured to output a first action of a control object according to an input of a first state of the control object, the policy training device including:
a memory, and
processor circuitry coupled to the memory and configured to:
change a first parameter regarding a constraint condition in the first reinforcement learning for every predetermined number of times of a training operation in the first reinforcement learning, and
train the first agent by using the first parameter as at least a part of the first state and by ensuring that the constraint condition is satisfied.

10. The communication system according to claim 9,
wherein the processor circuitry is further configured to:
determine a change range of the first parameter, according to a cost when the control object performs a second action output from a second agent trained through second reinforcement learning.
